(19) United States
(12) Patent Application Publication
(10) Pub. No.: US 2026/0128598 A1
(43) Pub. Date: May 7, 2026

(54) BATTERY PACK CHARGER WITH A HYBRID FLYBACK CONVERTER

(71) Applicant: MILWAUKEE ELECTRIC TOOL CORPORATION, Brookfield, WI (US)

(72) Inventors: Nicholas S. Brucks, Brookfield, WI (US); Vivek S. Nagal, Sussex, WI (US); Paul C. Chao, Menomonee Falls, WI (US)

(21) Appl. No.: 19/382,110

(22) Filed: Nov. 6, 2025

Related U.S. Application Data
(60) Provisional application No. 63/717,541, filed on Nov. 7, 2024.

(51) Int. Cl. H02J 7/06; H02J 7/00; H02M 1/00; H02M 1/44

(52) U.S. Cl. CPC H02J 7/06; H02J 7/92; H02M 1/0009; H02M 1/44; H02J 2207/20

(57) ABSTRACT

A battery pack charger having housing including a battery pack interface for removably receiving a battery pack and a power input. The battery pack charger including a hybrid flyback converter having a primary side including a DC-DC half-bridge and a secondary side including a synchronous rectifier. The hybrid flyback converter is electrically connected between the power input and the battery pack interface and is configured to provide charging power from the power input to the battery pack interface.

### RELATED APPLICATIONS

This application claims priority to U.S. Provisional Patent Application No. 63/717,541, filed November 7, 2024, the entire content of which is incorporated herein by reference.

### FIELD

The present disclosure relates to a converter assembly and particularly to a hybrid flyback converter for a battery pack charger.

### SUMMARY

Certain power tools operate using battery packs as their primary power source. The type of battery pack used varies depending on the power requirements of the specific power tool. Using a single charger capable of accommodating multiple battery types offers advantages in terms of space efficiency, cost savings, and convenience. To support faster charging across various battery types, the system may need to deliver increased total current. However, higher charging current can lead to elevated temperatures. Fans may be used to regulate the temperature of both the electronic components of the charger and the battery packs..

In some aspects, the techniques described herein relate to a battery pack charger including: a housing; a power input; a battery pack interface provided on the housing and configured to removably receive a battery pack; a hybrid flyback converter (HFC) having a primary side including a DC-DC half bridge and a secondary side including a synchronous rectifier electrically connected between the power input and the battery pack interface, the HFC configured to provide charging power from the power input to the battery pack interface; and a controller electrically connected to the HFC and configured to control an amount of power provided on the secondary side.

In some aspects, the techniques described herein relate to a battery pack charger including: a housing including a battery pack interface configured to removably receive a battery pack; a power input; a power circuit electrically connected between the power inpuit and the battery pack interface and configured to provide charging power from the power input to the battery pack interface; a fan provided within the housing and proximate the battery pack interface; an AC current sensor electrically connected between the power input and an input of the power circuit, the AC current sensor configured to measure an AC current; and a fan control circuit electrically connected to the AC current sensor and the fan, the fan control circuit configured to control the fan based on the AC current.

In some aspects, the techniques described herein relate to a method of controlling a fan for a battery pack charger, the method including: measuring an RMS AC current with an AC current sensor electrically connected between a power input of the battery pack charger and a battery pack interface of the battery pack charger, the battery pack interface configured to removably receive a battery pack; enabling the fan when the RMS AC current exceeds a first threshold; and disabling the fan when the RMS AC current subsequently drops below a second threshold.

### BRIEF DESCRIPTION OF THE DRAWINGS

FIG. 1 illustrates an example battery pack charger of according to some aspects of the disclosure herein.

FIG. 2 illustrates an example of a first-type battery pack receivable in the example battery pack charger of FIG. 1 according to some aspects of the disclosure herein.

FIG. 3 illustrates an example of a second-type battery pack receivable in the example battery pack charger of FIG. 1 according to some aspects of the disclosure herein.

FIG. 4 illustrates a block diagram of an example configuration of a battery pack charger according to some aspects of the disclosure herein.

FIG. 5 illustrates a main power circuit board assembly with a converter assembly according to some aspects of the disclosure herein.

FIG. 6 illustrates a block diagram for the converter assembly from FIG. 5 according to some aspects of the disclosure herein.

FIG. 7 illustrates a diagram of an example DC-DC half bridge used in the converter assembly of FIG. 6 according to some aspects of the disclosure herein.

FIG. 8 illustrates a block diagram of a low power auxiliary rail from the converter assembly of FIG. 6 according to some aspects of the disclosure herein.

FIG. 9 illustrates a block diagram of an example configuration of a battery pack charger with a fan according to some aspects of the disclosure herein.

FIG. 10 illustrates a flow chart for a method of controlling the fan from FIG. 5 according to some aspects of the disclosure herein.

FIG. 11 illustrates a first group configuration for the battery pack charger of FIG. 1 according to some aspects of the disclosure herein.

FIG. 12 illustrates a second group configuration for the battery pack charger of FIG. 1 according to some aspects of the disclosure herein.

FIG. 13 illustrates a flow chart of a method of controlling a fan for the battery pack charger of FIG. 1 according to some aspects of the disclosure herein.

Before any examples of the disclosure are explained in detail, it is to be understood that the disclosure is not limited in its application to the details of construction and the arrangement of components set forth in the following description or illustrated in the following drawings. The disclosure is capable of other examples and of being practiced or of being carried out in various ways. Also, it is to be understood that the phraseology and terminology used herein is for the purpose of description and should not be regarded as limiting.

The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

In addition, it should be understood that examples may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one example, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software-based devices, as well as a plurality of different structural components, may be utilized to implement the examples. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%, or more) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some examples, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Accordingly, in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

Other aspects of the examples will become apparent by consideration of the detailed description and accompanying drawings.

### DETAILED DESCRIPTION

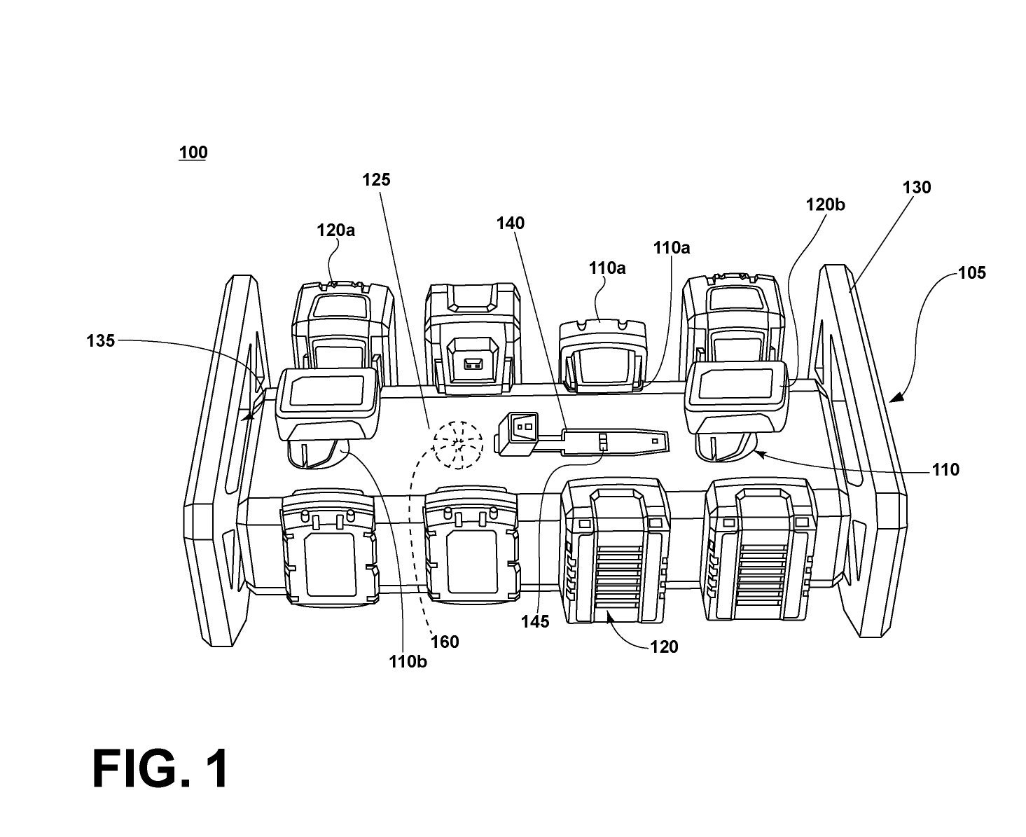

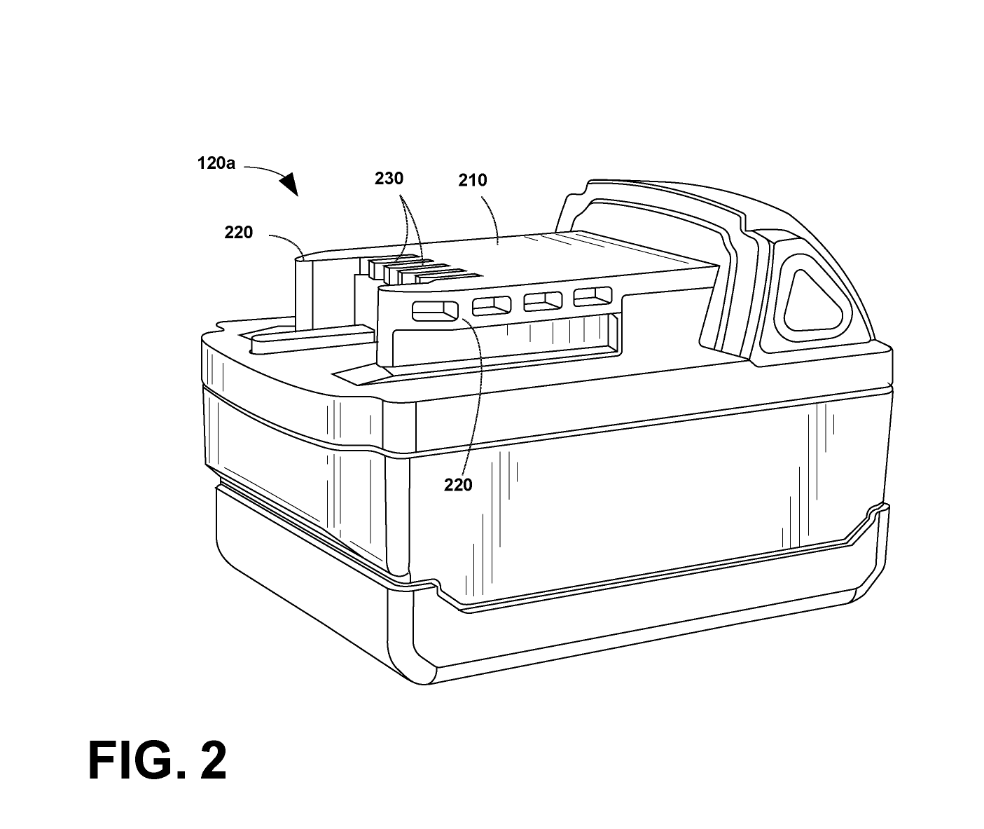

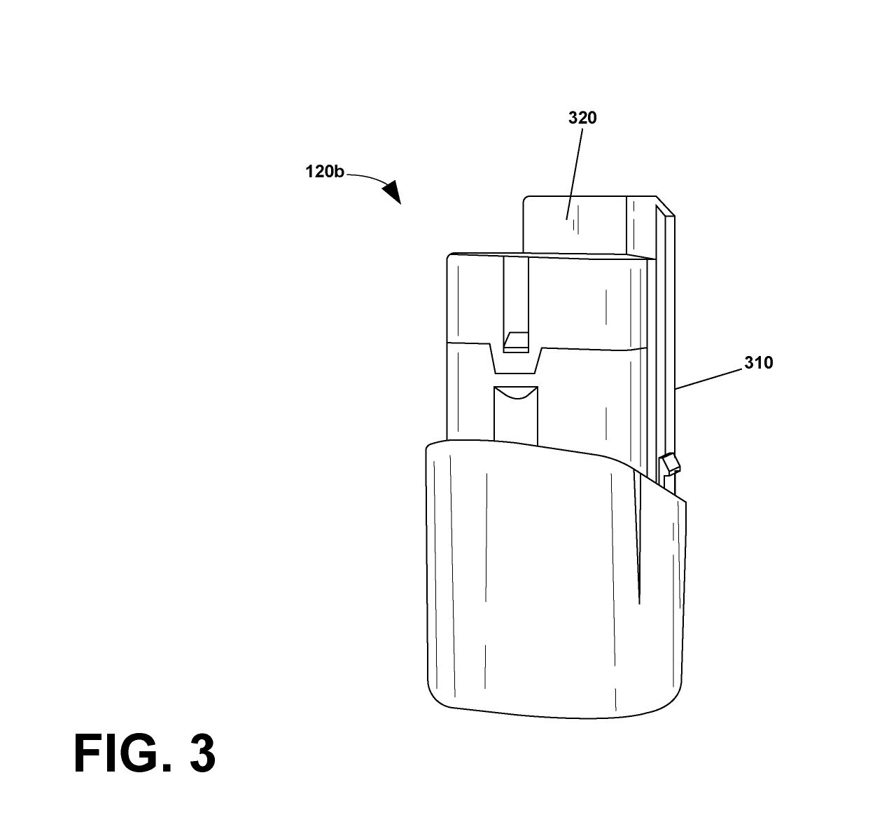

FIG. 1 illustrates an example battery pack charger 100 including a housing 105 and a plurality of battery pack interfaces 110 (e.g., one or more battery pack interfaces or receptacles). Each of the plurality of battery pack interfaces 110 is configured to receive a battery pack 120 and includes charger terminals corresponding to battery pack terminals of the battery pack 120 (e.g., battery pack terminals 230, FIG. 2, battery pack terminals 320, FIG. 3).

The battery pack charger 100 may be configured to charge different types of battery packs 120 (e.g., a first-type battery pack 120a, a second-type battery pack 120b). While two types of battery packs 120 are illustrated, a single type of battery pack 120 or any number of types of battery packs 120 are contemplated.

The housing 105 includes a middle console 125 and two bases 130 extending perpendicular to, and on opposite ends of, the middle console 125. The two bases 130 may include openings 135 forming handles for transporting the battery pack charger 100. The middle console 125 may include eight first-type battery pack interfaces 110a on two sides of the middle console 125, four on each side, and two second-type battery pack interfaces 110b on a top of the middle console 125. The first-type battery pack interfaces 110a are configured to removably (e.g., slidably) receive the first-type battery packs 120a. The second-type battery pack interfaces 110b are configured to removably (e.g., insertably) receive the second-type battery packs 120b.

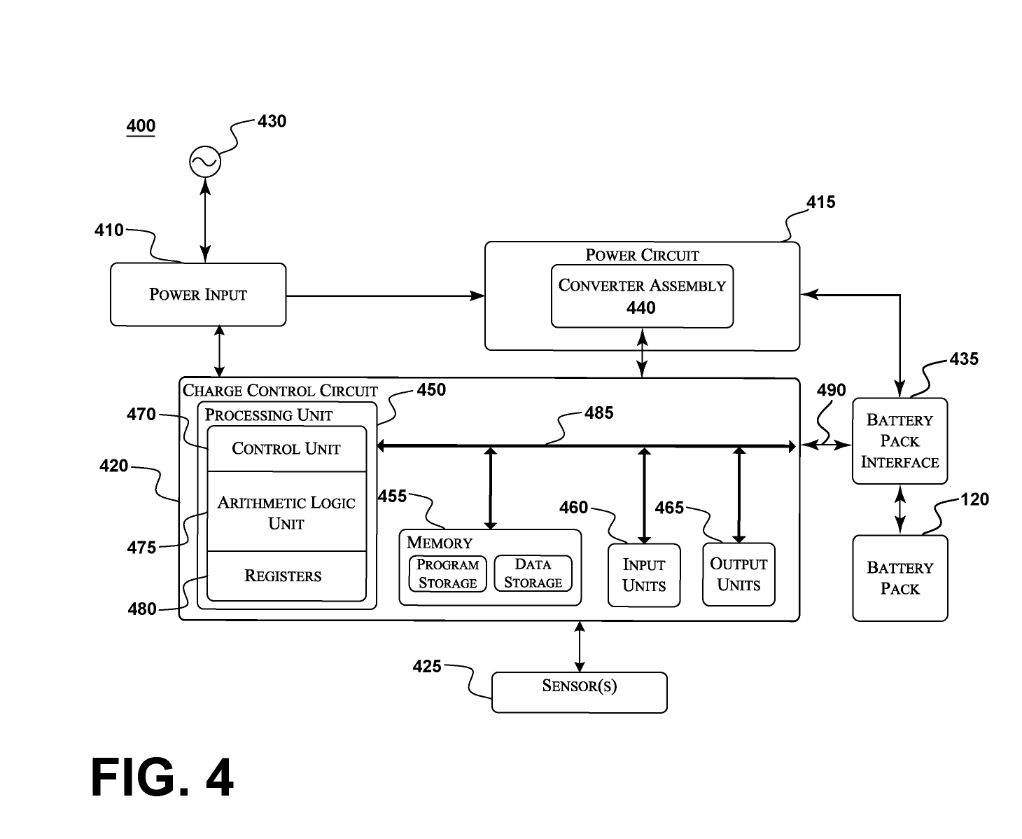

In one example the first-type battery pack 120a is an 18V battery pack and the second-type battery pack 120b is a 12V battery pack. The first-type battery pack 120a and the second-type battery pack 120b may additionally or alternatively have a different geometry (e.g., sliding style geometry, tower style geometry, etc.). The battery back charger 100 may further include one or more vents and a corresponding fan 160 located within the housing 105 for providing air circulation. The fan 160 may be configured to cool electronics within the housing 105 and/or the battery packs 120. The battery pack charger 100 may be configured for connection with a power source (FIG. 4) via a power input (FIG. 4). The battery pack charger 100 may have a total power output of about 760 Watts (760W) and a maximum total charging current of about 36 Amperes (36A).

The different types of battery packs 120 may include a high output battery pack (e.g., having a current capacity of 12amp-hours (Ah) or more). The different types of battery packs 120 may be, for example, a Lithium-ion chemistry-based power tool battery pack having a nominal voltage of about 18 Volts. The different types of battery packs may have a nominal voltage of about 36 Volts, 48 Volts, 72 Volts, or the like. Further, the different types of battery packs 120 may include a 12-volt power tool battery pack having three (3) Lithium-ion battery cells or may include fewer or more battery cells. Additionally, or alternatively, the battery cells may have chemistries other than lithium-ion such as, for example, nickel cadmium, nickel metal-hydride, or the like.

Each battery pack 120a, 120b may be connectable to and operable for powering various motorized power tools (e.g., a cut-off saw, a miter saw, a table saw, a core drill, an auger, a breaker, a demolition hammer, a compactor, a vibrator, a compressor, a drain cleaner, a welder, a cable tugger, a pump, etc.), outdoor tools (e.g., a chain saw, a string trimmer, a hedge trimmer, a blower, a lawn mower, etc.), other motorized devices (e.g., vehicles, utility carts, a material handling cart, etc.), and non-motorized electrical devices (e.g., a power supply, a light, an AC/DC adapter, a generator, etc.).

A user interface 140 may be disposed on the housing 105 for interacting with and controlling the battery pack charger 100. The user interface 140 may include, among other things, user inputs 145 for a user to interact with the battery pack charger 100. For example, a user may engage multiple battery packs 120 with the battery pack charger 100 and then provide a sequence regarding in what order and/or which battery packs 120 are charged first.

FIG. 2 illustrates the first-type battery pack 120a receivable in the first-type battery pack interface 110a according to an example. The first-type battery pack 120a may include a connection portion 210 with two parallel, spaced apart rails 220 such that first-type battery pack 120a is a slide-on-style battery pack for slidable engagement with the first-type battery pack interface 110a. The connection portion 210 also includes battery terminals 230 to electrically connect the first-type battery pack 120a to the charger terminals of the battery pack charger 100 or to another device, such as a power tool. In one example the first-type battery pack 120a is an 18V lithium chemistry-based battery pack.

FIG. 3 illustrates the second-type battery pack 120b receivable in the second-type battery pack interface 110b according to an example. The second-type battery pack 120b may include a connection portion 310 in the form of a tower-style for at least partial insertion into the second-type battery pack interface 110b. The connection portion 310 also includes battery terminals 320 to electrically connect the second-type battery pack 120b to charger terminals of the battery pack charger 100 or to another device, such as a power tool. In one example the second-type battery pack 120b is a 12V lithium chemistry-based battery pack.

The first-type battery pack 120a and the second type battery pack 120b are described as being slid and/or inserted into the battery pack charger 100. While slidable and insertable interfaces are illustrated, any type of interface capable of electrically connecting the different types of battery packs 120 to the battery pack charger 100 is contemplated including snapping, rotating, or the like.

FIG. 4 is a block diagram illustrating a configuration of a battery pack charger 400, e.g., the battery pack charger 100 of FIG. 1, according to one example. In the example shown, the battery pack charger 400 includes a power input 410, a power circuit 415, a controller 420, and one or more sensors 425. The one or more sensors 425 includes, for example, a current sensor, a voltage sensor, or the like.

The power input 410 may be connected to, for example, a power cord that can be plugged into a wall outlet to receive power from an electrical grid or a power generator (e.g., an external AC power source 430). The power input 410 may also include an interface to connect to a solar panel or other power source. The power input 410 is electrically connected to the power circuit 415, which is electrically connected to a battery pack interface 435. Although a single battery pack interface 435 is illustrated, the battery pack charger 400 may include a plurality of battery pack interfaces 435 as noted above.

In one example, the power circuit 415 includes an AC-DC converter (e.g., a rectifier) to convert AC power from the power input 410 into DC power and provide DC power to the battery pack 120 when engaged with the battery pack interface 435. The power circuit 415 includes a converter assembly 440 to convert input power to an appropriate power level (e.g., a requested power level different than the input power level) for charging a battery pack (e.g., the battery pack 120). The converter assembly 440 may include the AC-DC converter, or the AC-DC converter may be integral with the power input 410. The converter assembly 440 can be controlled by the controller 420 to change the amount of current or power provided on a secondary side (i.e., output side) of the converter assembly 440.

The controller 420 includes combinations of hardware and software that are operable to, among other things, control the operation of the battery pack charger 400. For example, the controller 420 includes, among other things, a processing unit 450 (e.g., a microprocessor, a microcontroller, an electronic processor, an electronic controller, or another suitable programmable device), a memory 455, input units 460, and output units 465. The processing unit 450 includes, among other things, a control unit 470, an arithmetic logic unit (“ALU”) 475, and a plurality of registers 480 (shown as a group of registers in FIG. 4) and is implemented using a known computer architecture (e.g., a modified Harvard architecture, a von Neumann architecture, etc.). The processing unit 450, the memory 455, the input units 460, and the output units 465, as well as the various modules or circuits connected to the controller 420 are connected by one or more control and/or data buses (e.g., common bus 485). The controller 420 may communicate with a battery pack controller of the battery pack 120 over a communication line 490. The control and/or data buses are shown generally in FIG. 4 for illustrative purposes. Although the controller 420 is illustrated in FIG. 4 as one controller, the controller 420 could also include multiple controller configured to work together to achieve a desired level of control for the battery pack charger 400. As such, any control functions and processes described herein with respect to the controller 420 could also be performed by two or more controllers functioning in a distributed manner. For example, the battery pack charger 400 may include one controller to communicate with the battery packs 120, and separate controllers (e.g., converter controllers) to control one or more converters within the power circuit 415.

The memory 455 is a non-transitory computer readable medium and includes, for example, a program storage area and a data storage area. The program storage area and the data storage area can include combinations of different types of memory, such as a read only memory (“ROM”), a random access memory (“RAM”) (e.g., dynamic RAM [“DRAM”], synchronous DRAM [“SDRAM”], etc.), electrically-erasable programmable ROM (“EEPROM”), flash memory, a hard disk, an SD card, or other suitable magnetic, optical, physical, or electronic memory devices. The processing unit 450 is connected to the memory 455 and is configured to execute software instructions that are capable of being stored in a RAM of the memory 455 (e.g., during execution), a ROM of the memory 455 (e.g., on a generally permanent basis), or another non-transitory computer readable medium such as another memory or a disc. Software included in the implementation of the battery pack charger 400 and controller 420 can be stored in the memory 455 of the controller 420. The software includes, for example, firmware, one or more applications, program data, filters, rules, one or more program modules, and other executable instructions. The controller 420 is configured to retrieve from the memory 455 and execute, among other things, instructions related to the control processes and methods described herein. In other examples, the controller 420 includes additional, fewer, or different components.

The battery pack charger 400 includes additional components that are omitted from the figures and this description for simplifying the description. For example, the battery pack charger 400 may include outlets to power external devices using power from the battery pack(s) 120. Additionally, the battery pack charger 400 may include various FETs and gate driver to control the FETs. For example, a charging FET may be connected between the power circuit 415 and the battery pack interface 435.

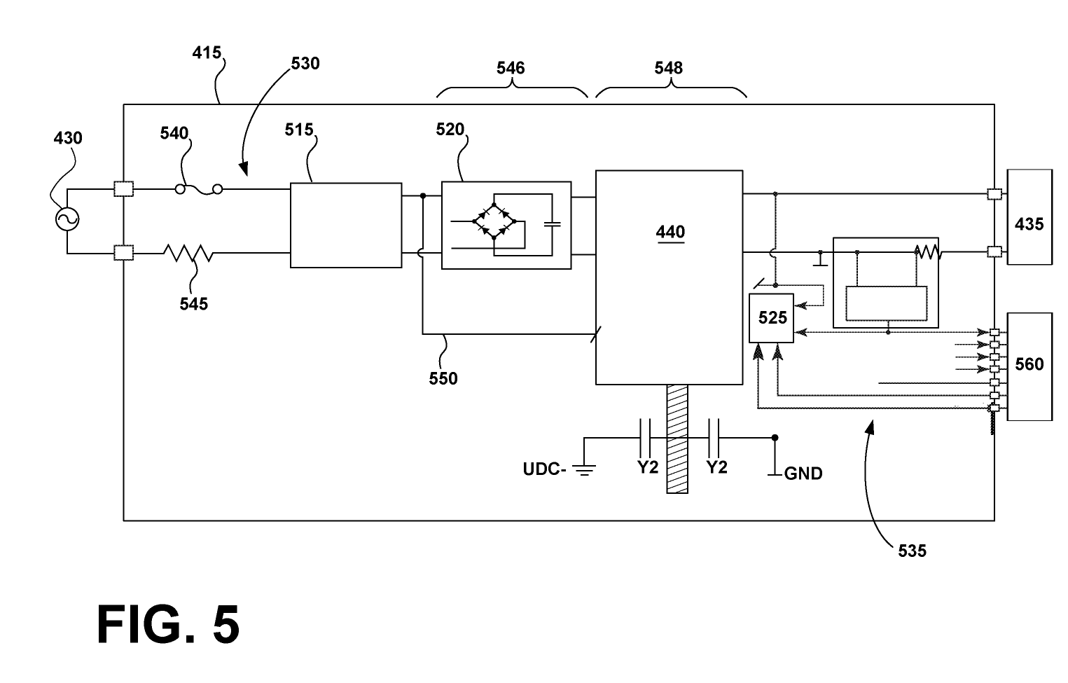

FIG. 5 is a block diagram of the power circuit 415 according to one example. The power circuit 415 may be electrically connected between the power source 430 and the battery pack interface 435. The power circuit 415 is electrically coupled to a charger controller 560 (e.g., a main controller of the battery pack charger 400). In the example illustrated, the power circuit 415 includes an electromagnetic interference (EMI) filter 515, an input rectifier 520, the converter assembly 440, and a constant current/constant voltage (CC/CV) control module 525. The CC/CV control module 525 provides fast charging without a risk of overcharging the battery pack 120 where the battery pack 120 is first charged at a constant current until it reaches a certain voltage, then the charging continues at that voltage while the current decreases. The power circuit 415 may include more or fewer components than those disclosed herein.

The power circuit 415 includes a main power path 530 and a control path 535. The main power path 530 provides operating (e.g., charging) power to the battery pack interface 435 from the power source 430. The control path 535 is used to exchange control and/or communication signals between the power circuit 415 (e.g., controllers and/or control components of the power circuit 415) and the charger controller 560. A fuse 540 and a negative temperature coefficient (NTC) thermistor 545 may be electrically connected between the power source 430 and the EMI filter 515. The fuse 540 and the NTC thermistor 545 provide protection to the power circuit 415 and/or the converter assembly 440 against power surges, overtemperature conditions, or the like.

The EMI filter 515 filters out electromagnetic interference in the AC power received from the power source 430. The filtered AC power from the EMI filter 515 is provided to the input rectifier 520. The input rectifier 520 converts the AC power from the power source 430 to DC power. A detection circuit 550 is coupled to the output of the EMI filter 515 to detect presence of the power source 430 on the main power path 530. The detection circuit 550 provides a detection signal to the converter assembly 440 to indicate the presence of AC power from the power source 430. The portion of the power circuit 415 from the power input to the output of the input rectifier 520 may form an AC-DC stage 546 of the power circuit 415. The charger controller 560 may be the main controller of the battery pack charger 100, 400 and controls the power supply to the battery pack receptacle(s). For example, the charger controller 560 may control the switches or relays connected between the power circuit 415 and the battery pack interface(s) 435 to enable and disable charging of the battery pack(s) 120. The charger controller 560 may also provide additional protection control (e.g., overtemperature, overvoltage, overcurrent, etc.) to the battery pack charger 100, 400.

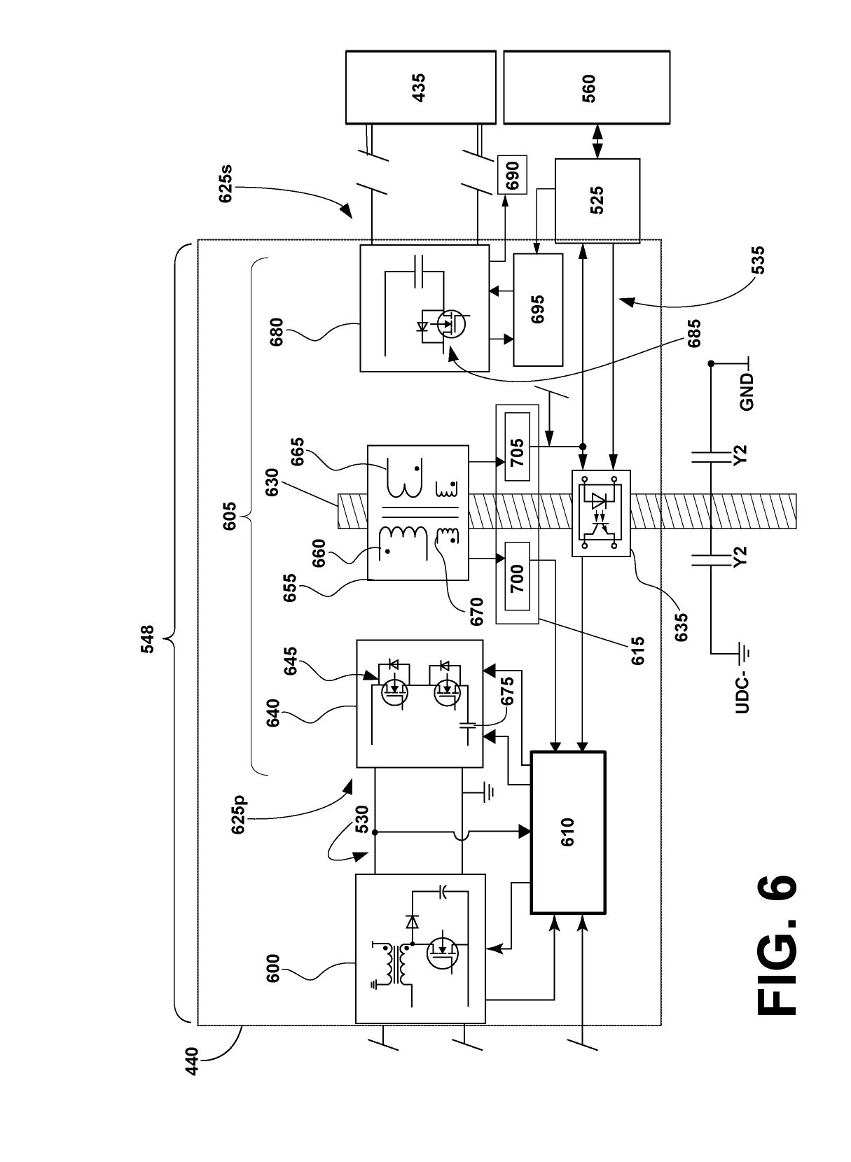

FIG. 6 illustrates a block diagram of the converter assembly 440 according to one example. The converter assembly 440 includes a power factor correction (PFC) converter 600, a hybrid flyback converter (HFC) 605, a converter controller 610, and a low power auxiliary rail 615, and a synchronous rectifier controller 695. The PFC converter 600 receives DC power from the input rectifier 520 and boosts the voltage to, for example 395V, 400V or the like, in comparison to a voltage (e.g., 110/120 Volts and 240 Volts) provided by the power source 430. In some examples, the PFC converter 600 may be omitted or replaced with a different type of DC-DC converter.

The HFC 605 includes a primary side 625p and a secondary side 625s. The HFC 605 is electrically connected on the primary side 625p to the PFC converter 600 and electrically connected on the secondary side 625s to the controller 420. A galvanic isolation barrier 630 separates high-voltage components (on the left, e.g., primary side 625p) from low-voltage components (on the right, e.g., secondary side 625s). The galvanic isolation barrier 630 may be provided by the HFC 605. A photocoupler assembly 635 may be used to exchange control signals between the high-voltage components and the low-voltage components across the galvanic isolation barrier 630.

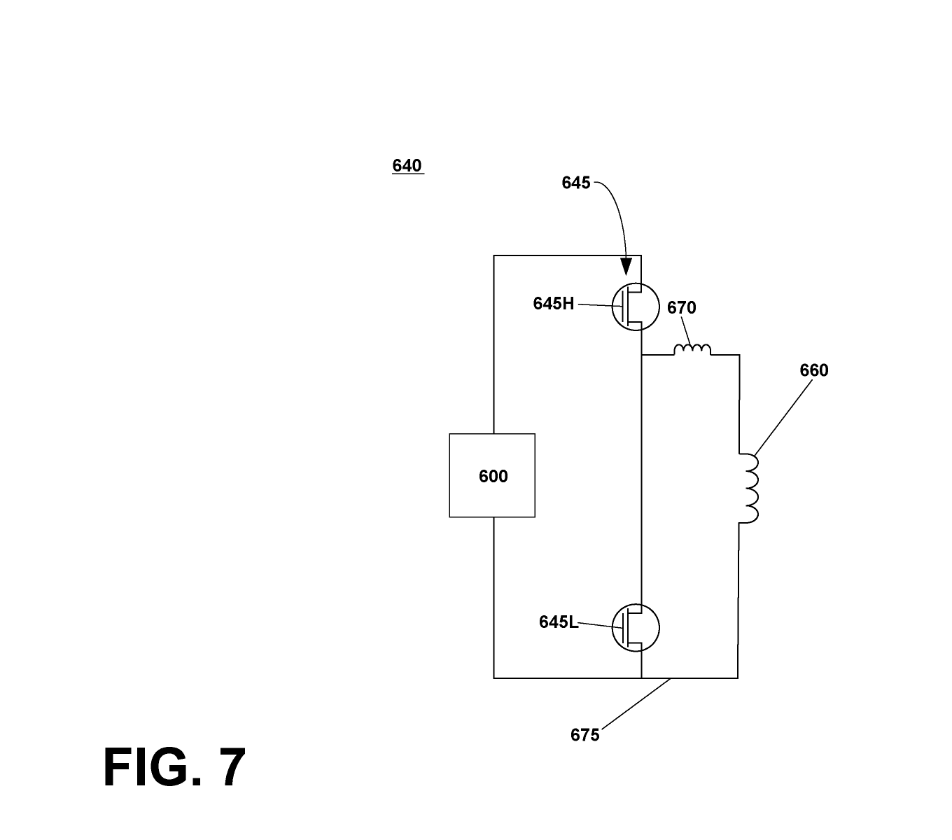

The HFC 605 includes the DC-DC half bridge 640 on the primary side 625p. FIG. 7 illustrates an example DC-DC half bridge 640 according to one example. The DC-DC half bridge 640 includes a plurality of switches 645 (e.g., a high-side switch 645H and a low-side switch 645L). The mid-point of the plurality of switches 645 is connected to one or more primary windings 660 via an inductor 670. A resonant capacitor 675 is electrically connected in series with the one or more primary windings 660 and the inductor 670.

Returning to FIG. 6, the HFC 605 includes a transformer 655 including the one or more primary windings 660 and corresponding one or more secondary windings 665. The transformer 655 forms the galvanic isolation barrier 630 in the main power path 530 and the photocoupler assembly 635 provides the galvanic isolation barrier 630 in the control path 535. The converter controller 610 is provided for controlling the plurality of switches 645. The converter controller 610 may include control features for the AC-DC stage 546 and the DC-DC stage 548 (e.g., DC-DC converter components between he output of the input rectifier 520 and the output of the HFC 605) that may be combined into a single chip. In other words, the converter controller 610 may combine a multimode AC-DC PFC controller and a multimode DC-DC hybrid-flyback controller into a single package enabling a reduction of external components and increasing the system performance by harmonizing operation of the two stages.

The HFC 605 includes a synchronous rectifier 680 on the secondary side 625s. The synchronous rectifier 680 includes at least one switch 685. The at least one switch 685 may be implemented as a MOSFET, a wide bandgap FET, or the like. The synchronous rectifier controller 695 is electrically connected to the synchronous rectifier 680 for controlling the at least one switch 685. The synchronous rectifier controller 695 may utilize a driver using flip-chip assembly technology for the HFC 605. The converter controller 610 controls the plurality of switches 645 and the synchronous rectifier controller 695 controls the switch 685 to convert the DC power between the AC-DC stage 546 and the battery pack interface 435 (FIG. 4).

The constant current/constant voltage (CC/CV) control module 525 is electrically connected to the charger controller 560, the photocoupler assembly 635, and the rectifier controller 695. A current sensor 690 is provided on the secondary side 625s to detect the current being provided to the battery pack interface(s) 435. The CC/CV control module 525 may provide signals to the converter controller 610 and the synchronous rectifier controller 695 based on the current detected by the current sensor 690 and/or control signals received from the charger controller 560.

The low power auxiliary rail 615 is provided independent of the main power path 530. The low power auxiliary rail 615 includes a first control circuit 700 on the primary side 625p of the HFC 605 and a second control circuit 705 on the secondary side 625s of the HFC 605. The low power auxiliary rail 615 is used to provide operating power at a lower power level (e.g., 15 volts, 5 volts, or the like) to the control components of the power circuit 415.

Advantages associated with incorporating the converter assembly 440 having the HFC 605 include high efficiency over a wide input range. The converter assembly 440 may be used with power supplies ranging from 90VAC to 265 VAC and for power ratings ranging from 140W to 300W. The converter assembly 440 with the HFC 605 also includes high efficiency for a wide output range making the converter assembly 440 useful in battery chargers. The transformer 655 and resonant capacitor 675 store energy during switching which results in a smaller transformer size and therefore higher power density. Energy stored in transformer leakage inductance can be recycled for increased efficiency. With proper control of the switches 645, 685, energy stored in the resonant capacitor 675 can be used to achieve Zero Voltage Switching (ZVS) on the plurality of switches 645 and Zero Current Switching (ZCS) on the at least one switch 685. ZVS and ZCS also increase efficiency. In one aspect, the converter assembly 440 with the HFC 605 is capable of 93% or higher efficiency at full load.

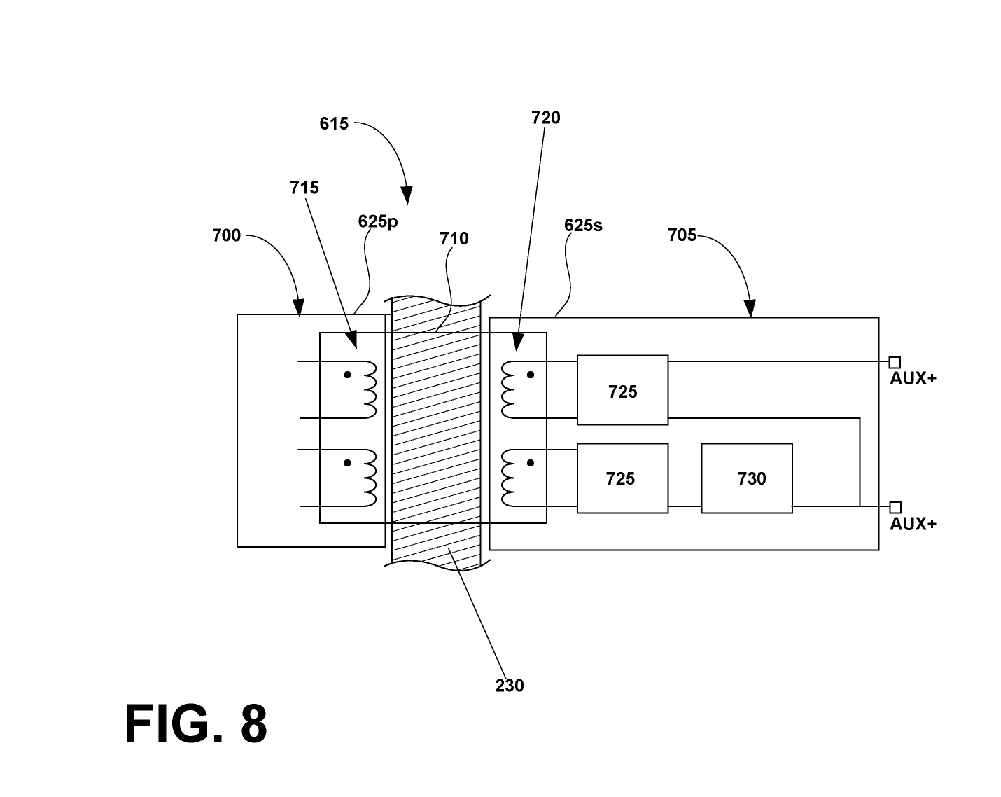

FIG. 8 illustrates a block diagram of the low power auxiliary rail 615 that is provided independent of the main power path 530. The low power auxiliary rail 615 includes the first control circuit 700 on the primary side 625p of the HFC 605 and the second control circuit 705 on the secondary side 625s of the HFC 605. The low power auxiliary rail 615 includes a housekeeping transformer 710 and provides a housekeeping power supply to all electrical components of a battery pack charger, e.g., battery pack charger 100 (FIG. 1) and/or battery pack charger 400 (FIG. 4). The housekeeping transformer 710 may include an additional winding to the one or more windings of the transformer 655. The first control circuit 700 includes a pair of primary windings 715 and the second control circuit includes a corresponding pair of secondary windings 720. The second control circuit 705 also includes two DC restorers 725 and a linear regulator 730. Rather than utilizing a rectifier, the DC restorers 725 provide better cross regulation. The switches 645, 685 can be used to transfer energy to the low power auxiliary rail 615 when the main power path 530 is switched off. Stacking the DC restorers 725 increases output voltage at light loads (<0.5W). The output voltage may be increased from 5V to 15V. The linear regulator 730 protects downstream circuits from overvoltage.

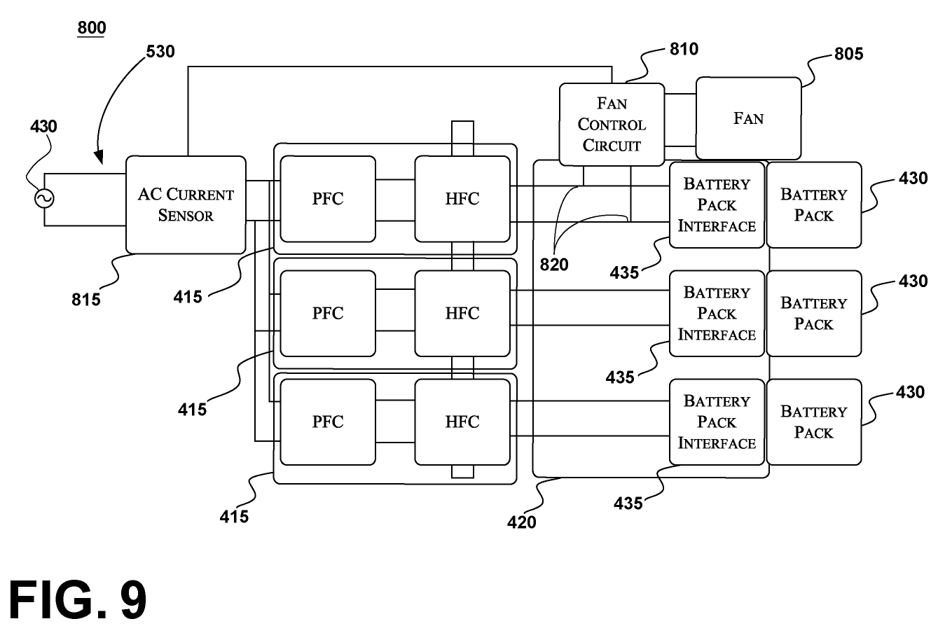

Turning to FIG. 9, a battery pack charger 800 according to one example. The battery pack charger 800 may include some or all of the features (not all illustrated for simplicity) described with respect to battery pack chargers 100, 400 including three dedicated power circuits 415 each having a PFC/HFC configuration described with respect to FIG. 6 and a control circuit including three battery pack interfaces 435 like those previously described herein. The battery pack charger 800 includes a fan 805 (e.g., the fan 160) provided proximate to the battery pack interfaces 110. A fan control circuit 810 is electrically connected to the fan 805. An AC current sensor 815 is electrically connected to the fan control circuit 810 to be used as feedback for controlling the fan 805. In one example, the AC current sensor 815 may be provided along the main power path 530 in electrical communication with the fuse 540 and/or the NTC thermistor 545 illustrated in FIG. 5. When the AC current sensor 815 senses an input current that exceeds a certain value, the fan control circuit 810 will turn the fan 805 ON. The fan 805 may be 24 Volt (24V) rated. Power for operating the fan 805 may be received from an output 820 of one of the three power circuits 415 for controlling current provided to the battery packs 120 (12.5V-21V). The fan control circuit 810 may include a controller (e.g., controller 420) and a switch or relay electrically connected between the power circuit 415 and the fan 805. The controller may open and close the switch or relay based on the measured AC current from AC current sensor 815 to control the fan 805.

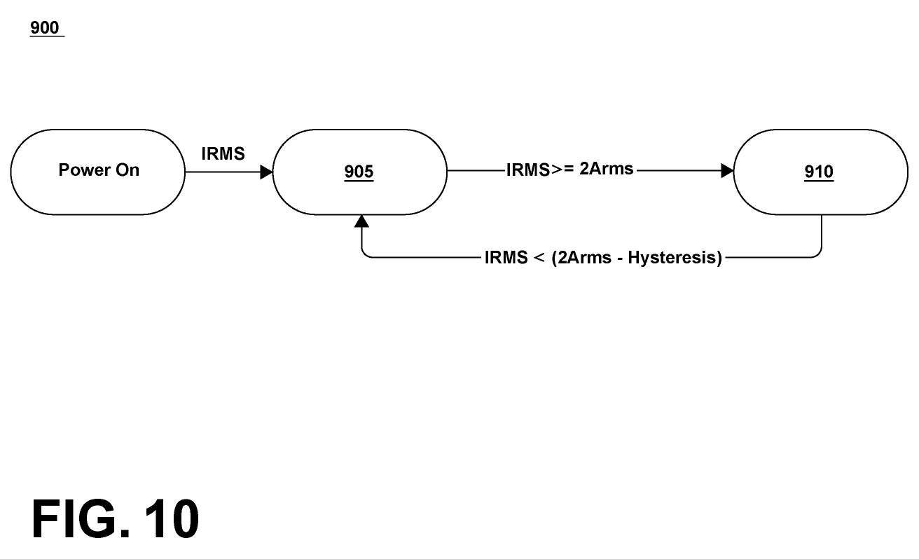

FIG. 10 illustrates a state machine 900 illustrating control of the fan 805. In a first state 905 the fan is disabled, either turned off or remains off. In a second state 910, the fan is enabled, or turned on. When current (IRMS) associated with power to the battery pack charger 800 being turned on is sensed by the AC current sensor 815, the fan 805 may remain in the first state 905. For example, when the detection circuit 550 provides a detection signal to the converter assembly 440 to indicate the presence of AC power from the power source 430, the fan 805 is not immediately turned on. Rather until the IRMS measured exceeds a first threshold, by way of example 2 Amperes Root Mean Square (ARMS), the fan remains in the first state 905. In a second state 910 the fan is enabled, or turned on, when the IRMS measured meets or exceeds the first threshold. The fan 805 returns to the first state 905 when the IRMS measured subsequently drops below a second threshold, by way of example 2 ARMS minus an amount due to hysteresis.

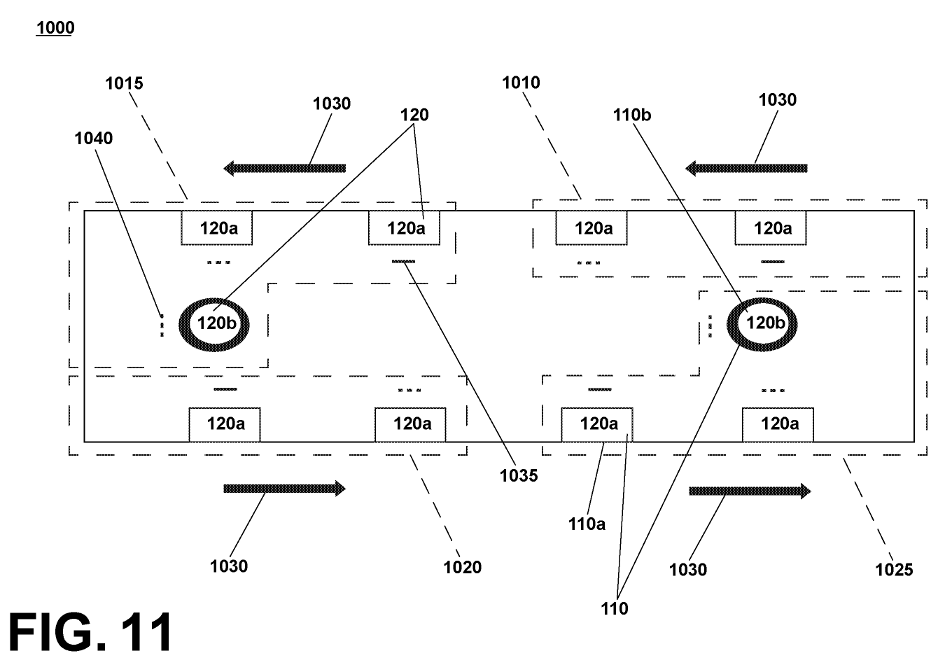

FIG. 11 illustrates a first charging configuration 1000 for battery pack charger 100 (or battery pack charger 400) according to an aspect of the disclosure herein. In the first charging configuration 1000 the battery pack charger 100 is split into multiple groups, a first group 1010 includes a first plurality of battery pack interfaces 110 (e.g., two first-type battery pack interfaces 110a), a second group 1015 includes a second plurality of battery pack interfaces 110 (e.g., two first-type battery pack interfaces 110a and one second-type battery pack interface 110b), a third group 1020 includes a third plurality of battery pack interfaces 110 (e.g., two first-type battery pack interfaces 110a), and a fourth group 1025 includes a fourth plurality of battery pack interfaces 110 (e.g., two first-type battery pack interfaces 110a and one second-type battery pack interface 110b).

In the example configuration, each group may charge only one battery pack 120 pack at a given time in the order that the battery packs 120 are inserted. However, multiple groups can charge a battery pack 120 simultaneously. In one example, when all of the battery pack interfaces 110 are accommodated with the battery packs 120 prior to an AC power up, the battery pack interfaces 110 will be prioritized from right to left for the first and second groups 1010, 1015, and from left to right for the third and fourth groups 1020, 1025 as illustrated by arrows 1030 (e.g., a counterclockwise direction). A different configuration or charging sequency may also be used to prioritize charging between the various inserted battery packs 120 (e.g., according to a user input via the user interface 140).

Further, the first-type battery packs 120a are prioritized such that, for the example previously described, in the second and fourth groups 1015, 1025, the first-type battery packs 120a will be charged first and second and the second-type battery packs 120b will be charged third. In the illustrated example, the solid line 1035 represent a battery pack 120 being charged and a dotted line 1040 represent a battery pack 120 waiting to be charged.

In another example, when the battery pack charger 100 is already plugged into the power source (FIG. 1), and no battery packs 120 are present, the first battery pack 120 to be placed will begin to charge. In this example, when a second-type battery pack 120b is inserted before a first-type battery pack 120a, the second-type battery pack 120b is given priority. In other words, regardless of the type of battery pack 120 inserted, the first one inserted will begin charging immediately.

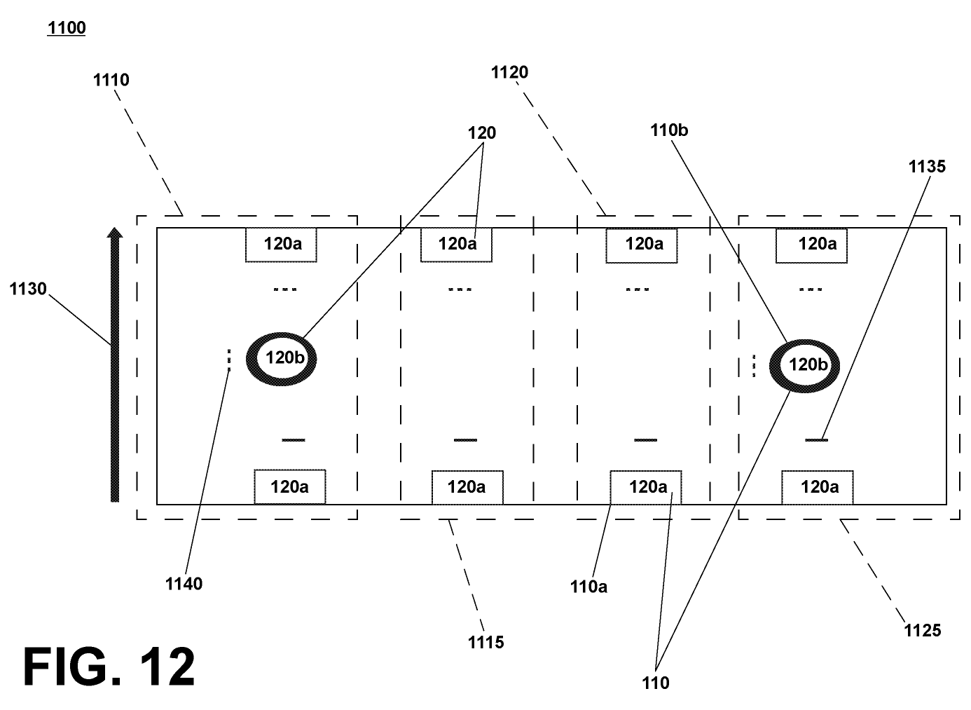

FIG. 12 illustrates a second charging configuration 1100 for battery pack charger 100 according to an aspect of the disclosure herein. In the second charging configuration 1100, a first group 1110 and a fourth group 1125 both include two first-type battery pack interfaces 110a and one second-type battery pack interface 110b, a second group 1115 and a third group 1120 both include two first-type battery pack interfaces 110a.

In the example configuration, each group may charge only one battery pack 120 at a given time in the order that the battery packs 120 are inserted. However, multiple groups may charge a battery pack 120 simultaneously. In one example, when all of the battery pack interfaces 110 are accommodated with the battery packs 120 prior to an AC power up, the battery pack interfaces 110 will be prioritized from bottom to top for all of the groups 1110, 1115, 1120, 1125 as illustrated by arrow 1130. For the first and fourth groups 1110, 1125, the first-type battery packs 120a (e.g., bottom) may be charged first, the second-type battery packs 120b may be charged second, and the other (e.g., top) first-type battery packs 120a may be charged last. In the illustrated example, the solid line 1135 represents a battery pack 120 being charged and a dotted line 1140 represent a battery pack 120 waiting to be charged.

In another example, when the battery pack charger 100 is already plugged into the power source (FIG. 1), and no battery packs 120 are present, the first battery pack 120 to be placed will begin to charge. In this example, when a second-type battery pack 120b is inserted before a first-type battery pack 120a, the second-type battery pack 120b is given priority.

A maximum charging current 36A may be distributed among the multiple interfaces 110, including the first-type battery pack interfaces 110a and the second-type battery pack interfaces 110b. The battery back charger 100 may be able to distribute the maximum charging current 36A in different ways depending on different combinations of battery types.

The first-type battery pack interface 110a is configured to provide a charging power at a maximum voltage of 21V and a maximum current of 36 A (that is, maximum power of 760 Watts) to the first-type battery pack 120a. The second-type battery pack interface 110b is configured to provide a charging power at a maximum voltage of 12.6V and a maximum current of 20 A (that is, maximum power of 252 Watts). A maximum power of 700 W to 800 W (for example, at 775 Watts or 792 Watts) at a maximum current of 36 A may be distributed between a maximum of four battery packs connected to the battery pack charger 100 in the example configuration illustrated. In other example configurations a different number of maximum battery packs may be charged using a different maximum power at a different maximum current.

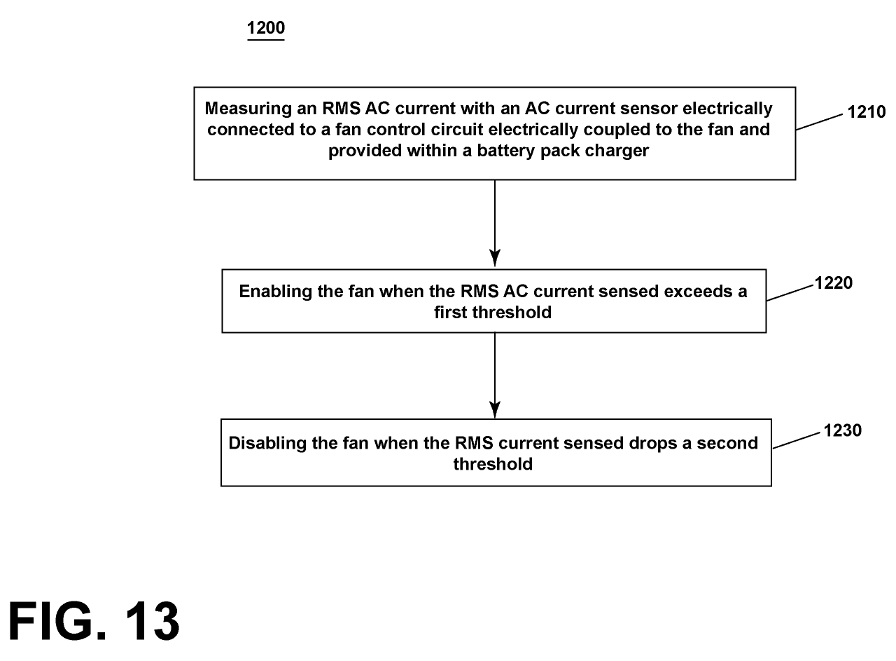

FIG. 13 illustrates a flow chart of a method 1200 for controlling the fan 805 for the battery pack charger 800. The method 1200 may be carried out by the controller 420 using the processing unit 450 according to the state machine 900 using the memory 455 for storage and the logic arithmetic logic unit 475 to determine the next state 905, 910 based on input units 460 (see FIGS. 4 and 10).

At block 1210, the method 1200 includes measuring an RMS AC current. By way of example, the RMS current may be sensed and measured with the AC current sensor 815 electrically connected to the fan control circuit 810 and provided within the battery pack charger 800. Monitoring and measurement of the AC current for the battery pack charger 800 using the state machine 900 may occur whilst the fan 805 is off. In one example, monitoring occurs at a sampling rate of between 10Hz and 1kHz. Real-time control of the AC current sensor 815 may occur at a rate of 100Hz which balances responsiveness and processing load.

At block 1220, the method 1200 includes enabling (turning on) the fan 805 when the RMS AC current exceeds the first threshold. In one example, when the amount of RMS AC current measured by the AC current sensor 815 exceeds 2 ARMS. More specifically, the AC current sensor 815 may be a Hall Effect sensor configured to output a voltage measurement based on the RMS AC current, an Analog-to-Digital Converter (ADC) reads the voltage, the control unit 470 converts the voltage to a current value and compares the current value to the first threshold. When the current value exceeds the first threshold, for example 2 ARMS, the processing unit 450 outputs a signal to enable the fan 805. While 2 ARMS is illustrated (FIG. 10), other threshold values are contemplated.

At block 1230, the method 1200 includes disabling (e.g., turning off) the fan 805 when the current sensed drops below the second threshold. In one example, when the amount of RMS AC current measured by the AC current sensor 815 drops below 2 ARMS. The second threshold may be lower than the first threshold by an amount equal to hysteresis. More specifically, hysteresis may be a predetermined amount of 0.5 AMRS, and when the current value drops below the second threshold, for example 1.5 ARMS, the processing unit 450 outputs a signal to disable the fan 805. It should be understood that the first and second thresholds may vary depending on implementation and predefined values based on the circuitry of the controller 420. For example, the first threshold may be 3 ARMS and the second threshold may be 2 ARMS where the predetermined hysteresis is 1 ARMS.

Although detailed description is provided with reference to certain preferred examples, variations and modifications exist within the scope and spirit of one or more independent aspects described herein.

What is claimed is:

1. A battery pack charger comprising:
a housing;
a power input;
a battery pack interface provided on the housing and configured to removably receive a battery pack;
a hybrid flyback converter (HFC) having a primary side including a DC-DC half bridge and a secondary side including a synchronous rectifier electrically connected between the power input and the battery pack interface, the HFC configured to provide charging power from the power input to the battery pack interface; and
a controller electrically connected to the HFC and configured to control an amount of power provided on the secondary side.

2. The battery pack charger of claim 1, further comprising:
an input rectifier electrically connected between the power input and the HFC, the input rectifier configured to convert AC power from the power input to DC power, wherein the DC power is provided to the HFC.

3. The battery pack charger of claim 2, wherein the HFC includes a plurality of switches, and wherein the controller is configured to control the plurality of switches to convert DC power between the power input and the battery pack interface.

4. The battery pack charger of claim 3, further comprising a power factor correction (PFC) boost converter electrically connected between the input rectifier and the DC-DC half bridge of the hybrid flyback converter.

5. The battery pack charger of claim 4, wherein the controller includes a single controller to control the PFC boost converter and the HFC converter provided on a single chip.

6. The battery pack charger of claim 1, wherein the synchronous rectifier includes at least one switch, wherein the at least one switch is a MOSFET.

7. The battery pack charger of claim 1, further comprising a fan provided within the housing and configured to cool electronics within the housing and/or the battery pack.

8. The battery pack charger of claim 7, further comprising:
an AC current sensor provided in a current path between the power input and the battery pack interface; and
a fan control circuit electrically connected to the AC current sensor and configured to control the fan based on AC current measured by the AC current sensor.

9. The battery pack charger of claim 1, wherein the battery pack interface is a first-type battery pack interface configured to receive a first-type battery pack, further comprising a second-type battery pack interface provided on the housing and configured to receive a second-type battery pack of a different type than the first-type battery pack.

10. The battery pack charger of claim 9, wherein the first-type battery pack having a nominal voltage of 18V and the second-type battery pack having a nominal voltage of 12V.

11. The battery pack charger of claim 1, further comprising a plurality of battery pack interfaces on the housing, the plurality of battery pack interfaces split into groups, each group including at least two battery pack interfaces.

12. The battery pack charger of claim 11, wherein a first group includes a plurality of first-type battery pack interfaces, and a second group includes a plurality of first-type battery pack interfaces and one second-type battery pack interface.

13. The battery pack charger of claim 12, wherein only one battery pack in each group charges at a time.

14. The battery pack charger of claim 1, wherein a total power output of the battery pack charger is 760 Watts.

15. A battery pack charger comprising:
a housing including a battery pack interface configured to removably receive a battery pack;
a power input;
a power circuit electrically connected between the power input and the battery pack interface and configured to provide charging power from the power input to the battery pack interface;
a fan provided within the housing and proximate the battery pack interface;
an AC current sensor electrically connected between the power input and an input of the power circuit, the AC current sensor configured to measure an AC current; and
a fan control circuit electrically connected to the AC current sensor and the fan, the fan control circuit configured to control the fan based on the AC current.

16. The battery pack charger of claim 15, wherein the fan control circuit is configured to enable the fan when the AC current exceeds a first threshold.

17. The battery pack charger of claim 16, wherein the fan control circuit is configured to disable the fan when the AC current fall below a second threshold and the fan is enabled.

18. The battery pack charger of claim 17, wherein the AC current is measured as a root mean square (RMS) current, the first threshold is 2 ARMS, and the second threshold is a hysteresis amount below the first threshold.

19. A method of controlling a fan for a battery pack charger, the method comprising:
measuring an RMS AC current with an AC current sensor electrically connected between a power input of the battery pack charger and a battery pack interface of the battery pack charger, the battery pack interface configured to removably receive a battery pack;
enabling the fan when the RMS AC current exceeds a first threshold; and
disabling the fan when the RMS AC current subsequently drops below a second threshold.

20. The method of claim 19, wherein the second threshold is lower than the first threshold.
